(19) United States
(12) Patent Application Publication
(10) Pub. No.: US 2003/0110239 A1
(43) Pub. Date: Jun. 12, 2003

(54) Application distribution system, application distribution method, and application distribution program

(76) Inventors: Mika Sugumoto, Asaka-shi (JP); Tomoyuki Koshio, Yokohama-shi (JP)

Correspondence Address: BIRCH STEWART KOLASCH & BIRCH, PO BOX 747, FALLS CHURCH, VA, 22040-0747, US

(21) Appl. No.: 10/310,942

(22) Filed: Dec. 6, 2002

(30) Foreign Application Priority Data
Dec. 6, 2001 (JP) P. 2001-372961

(51) Int. Cl. G06F 15/16

(52) U.S. Cl. 709/219; 709/203

(57) ABSTRACT

According to the present invention, a server 11 distributes an application to a cellular phone. The server includes a first information acquisition unit which obtains model number information for the cellular phone in response to a distribution request signal received from the cellular phone, a database which stores capability information for the model number of each cellular phone and a program source that constitutes the base of an application to be distributed, a second information acquisition unit which obtains from the database optimal program sources based on capability information that is consonant with model numbers, a generator which compiles the program sources obtained by the second acquisition unit, and a transmitter/receiver which distributes the generated application.

### BACKGROUND OF THE INVENTION

The present invention relates to an application distribution system, an application distribution method and an application distribution program for generating and distributing an optimal application for an information apparatus, in accordance with the performance and the operating environment of the information apparatus.

In consonance with recent dramatic advances in communication techniques and the preparation of communication infra-structures, on-line distribution service have become common whereby servers belonging to service providers and user information apparatuses, such as cellular phones or mobile terminals, can be connected via networks, thereby facilitating the distribution of applications to be employed by the information apparatuses.

Among the information apparatuses such as cellular phones, The display capability, such as for a 2D (two-dimensional) or a 3D (three-dimensional) display, or the processing capability, including a processing speed that varies in consonance with the type of CPU (Central Processing Unit) mounted in the information apparatus, differs depending on the model of the information apparatus. Therefore, for an on-line distribution service, the service provider must generate and prepare in advance an application for each type of information apparatus.

Recently, models of the information apparatus have appeared for which programs are written in Java, an object-oriented program language for the preparation of distribution processing functions, or models that have as functions the photographing and the transmission and reception of digital images. Thus, the demanded functions become more diversified, and there are noticeable differences in the display and processing capabilities of the models that are presently available. Since the information apparatus model types continue to increase and become ever more varied, the in-advance preparation by conventional systems of optimal applications for all possible models is extremely difficult, and coping with requests received from users is a nearly impossible task.

### SUMMARY OF THE INVENTION

To resolve the conventional problems, it is one objective of the present invention to provide an application distribution system, an application distribution method and an application distribution program whereby, upon receiving an application distribution request from an information apparatus, an optimal application for the subject information apparatus can be generated and distributed in accordance with the performance and operating environment of the apparatus, without preparing the in-advance preparation of optimal applications for all possible models.

To achieve this objective, according to a first aspect of the present invention, an application distribution system includes: a server for generating an optimal application for an information apparatus in accordance with the performance and the operating environment of the information apparatus, wherein, upon receiving an application distribution request from the information apparatus, the server obtains an optimal program source, based on information concerning the capabilities of the information apparatus, and complies the program source to generate an application that satisfies the request submitted by the information apparatus.

Therefore, an optimal application for each available information apparatus model need not be prepared in advance; for upon the reception of an application distribution request from an information apparatus, an optimal application can be generated in accordance with the performance and the operating environment of the information apparatus from which the request is received.

According to a second aspect of the invention, for the application distribution system, the server includes: information acquisition means for obtaining model number information for the information apparatus that has submitted the application distribution request, and the capability information that is consonant with the model number. Therefore, when the model number information for the information apparatus has been obtained, the corresponding capability information can also be promptly acquired.

According to a third aspect of the invention, for the application distribution system, the server includes; storage means for storing, for the model number of each information apparatus, capability information that corresponds to the model number of the information apparatus and a program source that differs, depending on the performance or the operating environment of the information apparatus, wherein; based on the model number of the information apparatus that has issued the application distribution number, the capability information for the information apparatus is obtained from the storage means, and based on the capability information, the optimal program source is obtained from the storage means.

According to a fourth aspect of the invention, for the application distribution system, the information acquisition means includes: first information acquisition means for obtaining the model number information from the information apparatus; and

second information acquisition means for obtaining, from the storage means, capability information that is consonant with the model number information acquired by the first information acquisition means.

According to a fifth aspect of the invention, for the application distribution system, the server distributes the generated application to the information apparatus. Therefore, an optimal application can be distributed for the information apparatus that issued the application distribution request.

An apparatus for the present invention constitutes the server for the application distribution system according to one of the first to fifth aspects.

According to a sixth aspect of the present invention, an application distribution method, for generating an optimal application for an information apparatus in accordance with the performance and the operating environment of the information apparatus, comprises: a program source acquisition step of, upon-receiving an application distribution request from the information apparatus., obtaining an optimal program source, based on information concerning the capabilities of the information apparatus; and an application generation step of compiling the program source obtained at the program source acquisition step, and generating an application that satisfies the request submitted by the information apparatus.

According to a seventh aspect of the invention, the application distribution method further comprises: a distribution step of distributing, to the information apparatus, the application generated at the application generation step.

An application distribution program for the invention permits a computer to serve as the server according to one of the first to fifth aspects.

### BRIEF DESCRIPTION OF THE DRAWINGS

FIG. 1 is a diagram showing the configuration of an application distribution system according to one embodiment of the present invention; and

FIG. 2 is a sequence chart for explaining an application distribution method according to the embodiment of the invention.

### DETAILED DESCRIPTION OF THE PREFERRED EMBODIMENT

An application distribution system and an application distribution method according to an embodiment of the present invention will now be described in detail with reference to the drawings. Since an application distribution program for this invention is implemented as individual components of the application distribution system, an explanation for this program is included in the following description.

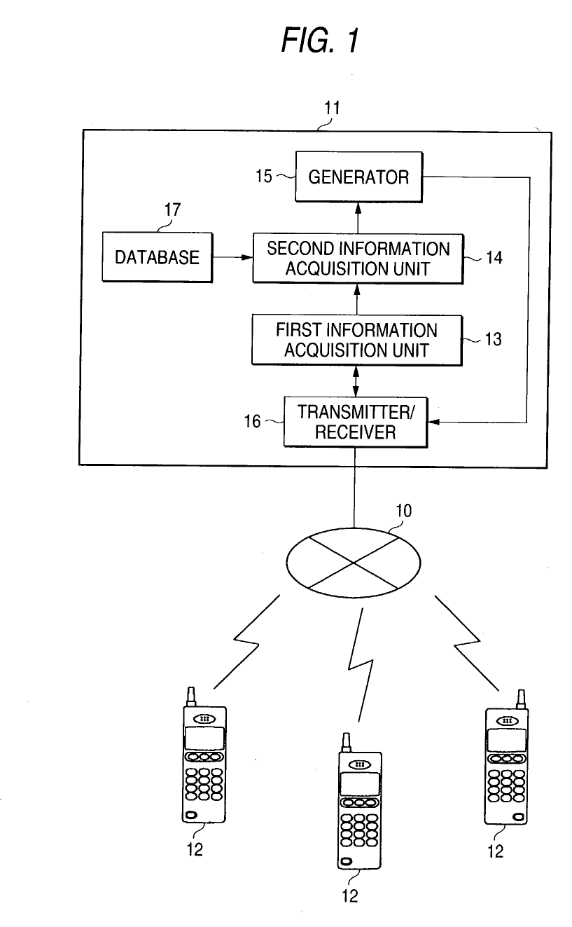

FIG. 1 is a diagram showing the configuration of an application distribution system according to the embodiment of the invention. In FIG. 1, the application distribution system includes a server 11, cellular phones 12 and a network 10, and the cellular phones 12 can be connected to the server 11 via the network 10. The server 11 is prepared on the side providing the service, and the cellular phones 12 are information apparatuses in the user side capable of executing an application distributed by the server 11 While for convenience sake only three cellular phones 12 are shown in FIG. 1, the model numbers of the cellular phones 12 differ, and accordingly, depending on the model numbers, their performances, such as the display and the processing capabilities and the operating environments, also differ.

The server 11 of the application distribution system of this embodiment will now be described in detail. Upon receiving an application distribution request from a cellular phone 12, the server 11 generates an appropriate application in accordance with the performance, such as the display capability and the processing capability, of the cellular phone 12 or the operating environment thereof, and distribution of the application to the cellular phone 12 is made. For this operation, as is shown in FIG. 1, the server 11 includes first and second information acquisition units 13 and 14, a generator 15, a transmitter/receiver 16, which corresponds to the distribution unit in the claims, and a database 17 which corresponds to the storage unit in the claims.

The transmitter/receiver 16 receives an application distribution request signal transmitted from an arbitrary cellular phone 12, or distributes to a predetermined cellular phone 12 an optimal generated application that will be described later. When the transmitter/receiver 16 receives an application distribution request signal, the first information acquisition unit 13 requests that model number information be provided by the cellular phone 12 that transmitted the distribution request signal.

The database 17 stores information (hereinafter referred to as “capability information”) concerning the performances and the operating environments of the cellular phones of each model of the cellular phones 12 in connection with the model number. As is shown in Table 1, example information, such as the type of CPU or MPU, a display resolution, a display color, an image format, a maximum application file size and a communication buffer size, is stored for each model number. Thus, depending on the type of CPU or MPU, for example, whether a cellular phone 12 can perform a floating-point arithmetic operation can be determined.

TABLE 1

Model number
CPU/MPU
Display resolution
Display color
Image format
Maximum application file size
Communication buffer size

Further, the source code for a program (hereinafter referred to as a program source), on which an application to be distributed to a cellular phone 12 is based, is stored in the database 17. In this embodiment, two types of program sources are used: a common program source, which is not affected by the performance and the operating environment of a cellular phone 12, and a partial program source, which differs in consonance with the performance or the operating environment of the cellular phone 12.

Based on the model number information obtained by the first information acquisition unit 13, the second information acquisition unit 14 obtains from the database 17 the capability information for the cellular phone 12 and, based on the capability information, the optimal partial program source. Then, together with the common program source, the second information acquisition unit 17 transmits to the generator 15 the optimal partial program source. Thereafter, the generator 15 compiles the program sources received from the second information acquisition unit 14 and generates an application to be distributed to the cellular phone 12. It should be noted that the common program source and the partial program source are first combined to form a single program source, and that the combined program source is then compiled.

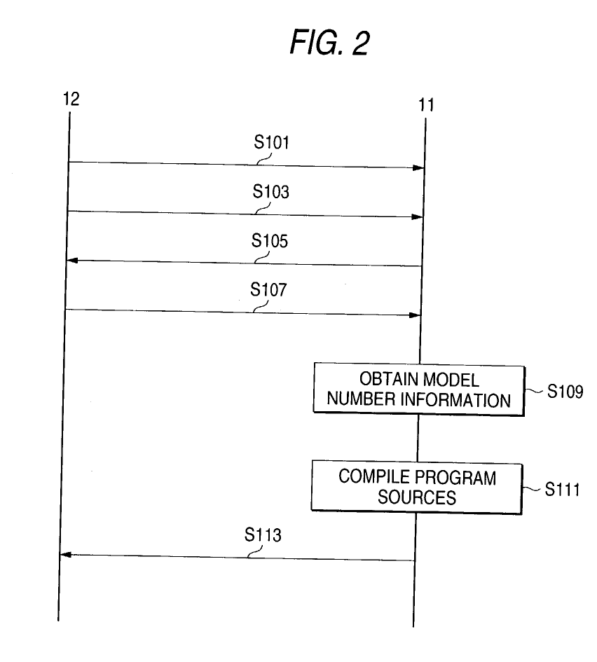

While referring to FIG. 2, an explanation will now be given for the application distribution method for this embodiment, which is regarded as an operation performed by the application distribution system, FIG. 2 is a sequence chart for explaining this application distribution method. First, a user accesses the server 11, using a cellular phone 12 (S101), and selects an application to be downloaded (S103). At this time, a request signal for the distribution of the selected application is transmitted to the server 11.

Upon receiving the application distribution request signal, the server 11 requests that the cellular phone 12 transmit its model number information (S105). Then, following the reception of this request, the cellular phone 12 transmits the model number information to the server 11 (S107), which, based on the thus acquired model number information, obtains from the database 17 the capability information for the cellular phone 12 (S109). Following this, based on the model number information obtained at step S109, the server extracts from the database 17 the common program source and the partial program source for the requested application, and compiles the program source including the common program source and the partial program source (S111). Finally, the server 11 distributes the generated application to the cellular phone 12 (S113).

As is described above, according to the application distribution system and the application distribution method employed for this embodiment, partial program sources, which differ depending on the performance or the operating environment of the cellular phone 12, are prepared for the server 11, and upon receiving an application distribution request from the cellular phone 12, the server 11 selects the optimal partial program source for the performance or the operating environment of the cellular phone, compiles a program source including the selected partial program source and the common program source, and generates an application.

Generally, the performance, such as the display capability or the processing capability, or the operating environment of the cellular phone 12 differ for each model number, and an application that permits the performance of an operation for the cellular phone 12 that issued an application distribution request must be distributed. Therefore, optimal applications for the individual model numbers must be prepared, and previously this has been difficult. However, in this embodiment, since an optimal application is generated for a cellular phone 12 when it issues an application distribution request, an optimal application can be distributed, for all model numbers, for the performance or the operating environment of the cellular phone 12.

In this embodiment, the capability information for each model number is stored in the database 17 of the server 11. However, each time an application distribution request is issued, the transmission of information equivalent to the capability information maybe requested from the cellular phone 12. In this case, an application distribution service can be, provided for a cellular phone 12 that is not registered in the database 17 and for which its performance, such as its display capability or processing capability, or its operating environment is unknown.

Further, in this embodiment, when the program source is being compiled by the server 11, the cellular phone must wait, while connected, for the distribution of the application. However, when excessive processing time is required for the compiling, a message to this effect, along with a URL whereat a generated application can be downloaded, can be transmitted to the cellular phone 12 In this case, a user can employ the cellular phone 12 to access the URL and to download the application at an arbitrary time. And the user can therefore download the application whenever it is convenient, while no communication fees and no time will be wasted.

In addition, in this embodiment, based on capability information that is consonant with the model number information for the cellular phone 12, the second information acquisition unit 14 has obtained the partial program source from the database 17. However, the partial program source may be obtained in consonance with the model number information. Further, although in this embodiment a cellular phone 12 has been used as the information apparatus that executes an application, a PC (Personal Computer) or a PDA (Personal Digital Assistant) may also be employed. Furthermore, an application to be distributed is not only an application that can be operated by a cellular phone 12, but also an application that can be operated and employed by a PC or a PDA.

In this embodiment, each time an application distribution request is issued, an application is generated and distributed. However, once an application has been generated, it may, in addition to being distributed, be stored in the database. In this case, when an application distribution request is issued by a cellular phone 12 having the same model number, the application stored in the database 17 can be distributed directly.

As described above, according to the application distribution system and the application distribution method, and the application distribution program for this invention, an optimal application need not be prepared in advance for each information apparatus model, and when an application distribution request is issued by an information apparatus, an optimal application for the information apparatus can be generated in accordance with the performance or the operating environment of the information apparatus.

What is claimed is:

1. An application distribution system comprising:
a server for generating an optimal application for an information apparatus in accordance with the performance and the operating environment of said information apparatus,
wherein said server obtains an optimal program source based on capability information of the information apparatus on receiving an application distribution request from the information apparatus, and
wherein said sever complies the program source to generate an application that satisfies the request submitted by the information apparatus.

2. The application distribution system as claimed in claim 1, wherein said server comprises:
an information acquisition unit for obtaining model number information for the information apparatus that has submitted said application distribution request and the capability information corresponding to the model number information.

3. The application distribution system as claimed in claim 2,
wherein said server further comprises a storage unit for storing capability information corresponding to the model number of each of the information apparatus, and also storing a program source that differs depending on the performance or the operating environment of said information apparatus,
wherein the capability information for the information apparatus is obtained from said storage unit based on the model number of the information apparatus that has issued the application distribution request, and the optimal program source is obtained from said storage unit based on the capability information.

4. The application distribution system as claimed in claim 3, wherein said information acquisition unit comprises:
a first information acquisition unit for obtaining the model number information from the information apparatus; and
a second information acquisition unit for obtaining, from said storage unit, capability information corresponding said model number information acquired by said first information acquisition unit.

5. The application distribution system as claimed in claim 1, wherein said server comprises a distribution unit for distributing the generated application to the information apparatus.

6. An apparatus constituting said server for the application distribution system as claimed in claim 1.

7. An application distribution method comprising:
obtaining an program source based on capability information of an information apparatus on receiving an application distribution request from the information apparatus; and
generating an application that satisfies the application distribution request and optimal the information apparatus in accordance with a performance and an operating environment of the information apparatus, by compiling the program source.

8. The application distribution method according to claim 7, further comprising:
distributing the application having been generated to the information apparatus.

9. An application distribution program which allows a computer to serve as said server as claimed in claim 1.
